(19) United States
(12) Patent Application Publication
(10) Pub. No.: US 2005/0150395 A1
(43) Pub. Date: Jul. 14, 2005

(54) Mobile chafing dish apparatus

(76) Inventors: Benson A. Olekaibe, Las Vegas, NV (US); Esther C. Olekaibe, Las Vegas, NV (US)

Correspondence Address: S. Michael Bender, P.O. Box 530-399, St. Petersburg, FL, 33715, US

(21) Appl. No.: 11/032,530

(22) Filed: Jan. 10, 2005

Related U.S. Application Data
(60) Provisional application No. 60/535,636, filed on Jan. 12, 2004.

(51) Int. Cl. A23C 15/04

(52) U.S. Cl. 99/483

(57) ABSTRACT

A mobile chafing dish apparatus includes a dish-support pan, a plurality of legs connected to the dish-support pan, and swivel caster wheel assemblies connected to respective distal ends of each of the legs. A fuel-support pan assembly is connected to the plurality of legs, and a plurality of chafing dishes are supported by the dish-support pan. With the mobile chafing dish apparatus of the invention, the mobile chafing dish apparatus can be easily moved along a table top surface by simply pulling on or pushing the apparatus. The dish-support pan includes pan handles located at ends of the dish-support pan. A transparent cover is supported by the dish-support pan. Preferably, fuel-burner-reception walls are supported by the fuel-support pan assembly. Fuel burners are received in regions defined by the respective fuel-burner-reception walls.

### CROSS-REFERENCE TO RELATED APPLICATION

This application claims priority based upon my copending Provisional Application Ser. No. 60/535,636, filed Jan. 12, 2004.

### BACKGROUND OF THE INVENTION

1. Field of the Invention

The present invention relates generally to devices for heating food and, more particularly, to mobile or portable devices especially adapted for heating food.

2. Description of the Prior Art

Mobile or portable devices for heating food are well known in the art. In this respect, throughout the years, a number of innovations have been developed relating to mobile or portable devices for heating food, and the following U.S. patents are representative of some of those innovations: U.S. Pat. Nos. 2,520,543, 4,665,888, 4,739,580, 6,267,111, and 6,591,831.

More specifically, each of U.S. Pat. Nos. 2,520,543, 4,665,888, 6,267,111, and 6,591,831 discloses a mobile device for heating foods. Each of the respective mobile devices has wheels that are supported at the ends of legs. Also, each of the respective mobile devices includes a housing which includes means for supporting the food to be heated and means for heating the food. The housing is generally provided so that the means for heating the food are supported by a floor in the housing. In this respect, the heating source is located at a fixed distance from the food that is being heated. To provide ease of control of the amount of heat from a heating source that is used for heating the food, it would be desirable if the heating source and the food that is heated were not supported by the same housing so that the distance between the heating source and the food that is heated could be changed.

U.S. Pat. No. 4,739,580 discloses a portable table in which food is contained in trays, and the trays can be heated by a heating source that is placed on a horizontal surface that supports the portable table. With such an arrangement for food support and heating source support, the food support is moved independently of the heating source. Therefore, when a move is contemplated, two separate moves must me made, one move for the food support and another move for the heating source. To avoid this duplication of movements, it would be desirable if a mobile heating device for foods were provided wherein both a food support and a heating source support were moved simultaneously when the mobile heating device were moved.

Still other features would be desirable in a mobile food heating apparatus. When a wheeled mobile food heating apparatus is moved along an uneven surface, the uneven surface can cause a bumping so that the lateral position of the heating sources are changed with respect to the food being heated. To prevent this displacement of heating sources from the food being heated, it would be desirable for means to be provided for securing the heating sources so that they are not displaced laterally from the food being heated when mobile food heating apparatus is moved.

Thus, while the foregoing body of prior art indicates it to be well known to use mobile food heating devices, the prior art described above does not teach or suggest a mobile chafing dish apparatus which has the following combination of desirable features: (1) provides that the heating source and the food that is heated are not supported by the same housing so that the distance between the heating source and the food that is heated can be changed; (2) provides that both a food support and a heating source support are moved simultaneously when the mobile heating device are moved; and (3) provides means for securing the heating sources so that they are not displaced laterally from the food being heated when the mobile food heating device is moved. The foregoing desired characteristics are provided by the unique mobile chafing dish apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a mobile chafing dish apparatus which includes a dish-support pan, a plurality of legs connected to the dish-support pan, and wheel assemblies connected to respective distal ends of each of the legs. A fuel-support pan assembly is connected to the plurality of legs, and a plurality of chafing dishes are supported by the dish-support pan. With the mobile chafing dish apparatus of the invention, the mobile chafing dish apparatus can be easily moved along a table top surface by simply pulling on or pushing the apparatus.

Preferably, the dish-support pan further includes a central dish support member extending upward from a central bottom portion of the dish-support pan. The dish-support pan includes pan handles located at ends of the dish-support pan. A cover is supported by the dish-support pan. The cover includes a cover handle. Preferably, the cover is transparent. Preferably, each of the wheel assemblies is a swivel caster assembly.

The fuel-support pan assembly includes a fuel-support pan member and pan-support struts connected between the fuel-support pan member and the legs. Preferably, fuel-burner-reception walls are supported by the fuel-support pan assembly. Fuel burners are received in regions defined by the respective fuel-burner-reception walls.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved mobile chafing dish apparatus which has all of the advantages of the prior art and none of the disadvantages.

It is another object of the present invention to provide a new and improved mobile chafing dish apparatus which may be easily and efficiently manufactured and marketed.

It is a further object of the present invention to provide a new and improved mobile chafing dish apparatus which is of durable and reliable construction.

An even further object of the present invention is to provide a new and improved mobile chafing dish apparatus which is susceptible of a low cost of manufacture with regard to both materials and labor, and which accordingly is then susceptible of low prices of sale to the consuming public, thereby making such mobile chafing dish apparatus available to the buying public.

Still yet a further object of the present invention is to provide a new and improved mobile chafing dish apparatus which provides that the heating source and the food that is heated are not supported by the same housing so that the distance between the heating source and the food that is heated can be changed.

Still another object of the present invention is to provide a new and improved mobile chafing dish apparatus that provides that both a food support and a heating source support are moved simultaneously when the mobile heating device is moved.

Yet another object of the present invention is to provide a new and improved mobile chafing dish apparatus which provides means for securing the heating sources so that they are not displaced laterally from the food being heated when the mobile food heating device is moved.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front view showing a preferred embodiment of the mobile chafing dish apparatus of the invention.

FIG. 2 is a side view of the embodiment of the mobile chafing dish apparatus shown in FIG. 1 taken along line 2-2 of FIG. 1.

FIG. 3 is a top view of the embodiment of the mobile chafing dish apparatus of FIG. 1 taken along line 3-3 thereof.

FIG. 4 is a cross-sectional view of the embodiment of the invention shown in FIG. 1 taken along line 4-4 thereof.

FIG. 5 is a partially exploded perspective view of the embodiment of the invention shown in FIGS. 1-4.

### DESCRIPTION OF THE PREFERRED EMBODIMENT

With reference to the drawings, a new and improved mobile chafing dish apparatus embodying the principles and concepts of the present invention will be described.

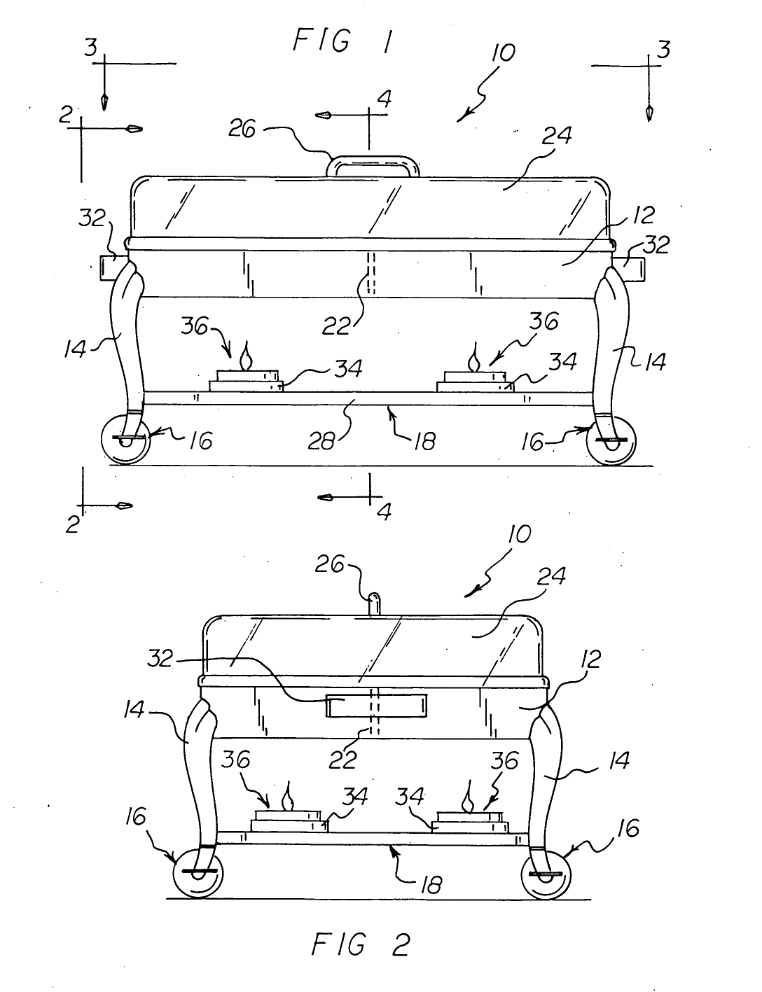

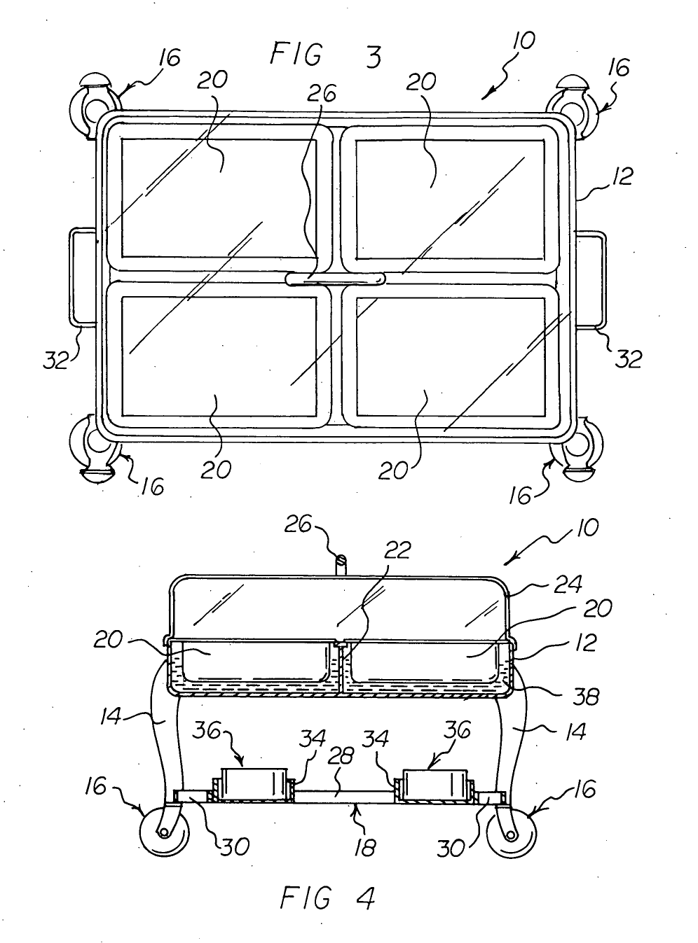

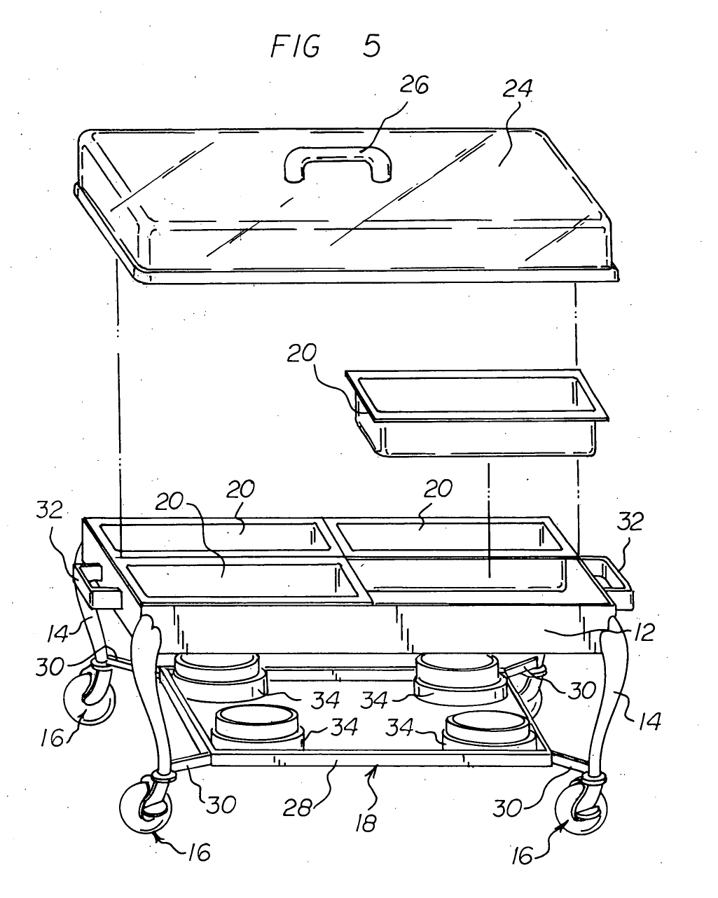

Turning to FIGS. 1-5, there is shown a preferred embodiment of the mobile chafing dish apparatus of the invention generally designated by reference numeral 10. In the preferred embodiment, mobile chafing dish apparatus 10 includes a dish-support pan 12, a plurality of legs 14 connected to the dish-support pan 12, and wheel assemblies 16 connected to respective distal ends of each of the legs 14. A fuel-support pan assembly 18 is connected to the plurality of legs 14, and a plurality of chafing dishes 20 are supported by the dish-support pan 12.

Preferably, the dish-support pan 12 further includes a central dish support member 22 extending upward from a central bottom portion of the dish-support pan 12. The dish-support pan 12 includes pan handles 32 located at ends of the dish-support pan 12. A cover 24 is supported by the dish-support pan 12. The cover 24 includes a cover handle 26. Preferably, the cover 24 is transparent.

Preferably, each of the wheel assemblies 16 is a swivel caster assembly. Preferably, each of the swivel caster assemblies 16 has a scratch resistant wheel. Also, preferably, each of the swivel caster assemblies 16 has a brake element for preventing mobility of the mobile chafing dish apparatus 10 of the invention when mobility prevention is desired. Caster assemblies 16 having brake elements are conventional.

The fuel-support pan assembly 18 includes a fuel-support pan member 28 and pan-support struts 30 connected between the fuel-support pan member 28 and the legs 14. The legs 14 can be stainless steel legs 14. Preferably, fuel-burner-reception walls 34 are supported by the fuel-support pan assembly 18. Fuel burners 36 are received in regions defined by the respective fuel-burner-reception walls 34. The fuel burners 36 are conventional such as candles or sterno fuel cans.

To use the mobile chafing dish apparatus 10 of the invention, a quantity of water 38 is placed in the dish-support pan 12. Then, food items are placed in the chafing dishes 20, and the chafing dishes 20 are placed in the dish-support pan 12. Flanged edges of the chafing dishes 20 are supported by walls of the dish-support pan 12 and by the central dish support member 22.

Fuel burners 36 are placed in the regions of the fuel-support pan member 28 defined by the fuel-burner-reception walls 34, and the fuel burners 36 are lit. The fuel burners 36 are conventional and are lit in a conventional way. The transparent cover 24 is placed over the chafing dishes 20 and the dish-support pan 12 to keep the food clean and warm until ready to be served. When the food is ready to be served, the transparent cover 24 is removed.

The mobile chafing dish apparatus 10 of the invention can easily be moved along a table top by a gentle push on the apparatus. When the brakes of the caster wheel assemblies 16 are released, a gentle push or pull on the mobile chafing dish apparatus 10 causes the mobile chafing dish apparatus 10 to move easily along the table top. The mobility of the mobile chafing dish apparatus 10 of the invention helps prevent long lines at a buffet service. By a simple push on the mobile chafing dish apparatus 10, a person can exercise self service. In addition, the mobile chafing dish apparatus 10 of the invention can be used on a table top when people are seated at the table. Without getting up from one's seat, a person can push or pull on the mobile chafing dish apparatus 10 to bring the food to the seated person.

Although dimensions can vary widely, it is convenient to provide chafing dishes 20, wherein each chafing dish 20 has an 8 quart capacity. Also, for convenience, there are 4 chafing dishes 20, and there are 4 fuel burners 36. Such an apparatus can serve large numbers of persons efficiently.

The mobile chafing dish apparatus of the invention can be designated Majestic Mobile (ESBEN) Chafer, among other designations.

If desired, the dish-support pan 12 and the legs 14 can be gold-plated or silver-plated.

The components of the mobile chafing dish apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved mobile chafing dish apparatus that is low in cost, relatively simple in design and operation, and which may advantageously be used to provide that the heating source and the food that is heated are not supported by the same housing so that the distance between the heating source and the food that is heated can be changed. With the invention, a mobile chafing dish apparatus is provided which provides that both a food support and a heating source support are moved simultaneously when the mobile heating device are moved. With the invention, a mobile chafing dish apparatus is provided in which means are provided for securing the heating sources so that they are not displaced laterally from the food being heated when the mobile food heating device is moved.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A mobile chafing dish apparatus, comprising:
a dish-support pan,
a plurality of legs connected to said dish-support pan, wheel assemblies connected to respective distal ends of each of said legs,
a fuel-support pan assembly connected to said plurality of legs, and
a plurality of chafing dishes supported by said dish-support pan.

2. The apparatus of claim 1 wherein said dish-support pan further includes a central dish support member extending upward from a central bottom portion of said dish-support pan.

3. The apparatus of claim 1 wherein said dish-support pan includes pan handles.

4. The apparatus of claim 1, further including:
a cover supported by said dish-support pan.

5. The apparatus of claim 4 wherein said cover includes a cover handle.

6. The apparatus of claim 4 wherein said cover is transparent.

7. The apparatus of claim 1 wherein each of said wheel assemblies is a swivel caster assembly.

8. The apparatus of claim 1 wherein said fuel-support pan assembly includes:
a fuel-support pan member, and
pan-support struts connected between said fuel-support pan member and said legs.

9. The apparatus of claim 1, further including:
fuel-burner-reception walls supported by said fuel-support pan assembly.

10. The apparatus of claim 9, further including:
fuel burners received in regions defined by said respective fuel-burner-reception walls.
